(19) United States
(12) Patent Application Publication
(10) Pub. No.: US 2026/0313694 A1
(43) Pub. Date: Oct. 8, 2026

(54) INITIAL CONNECTION METHOD AND APPARATUS FOR NETWORK-CONTROLLED REPEATER IN NEXT GENERATION MOBILE COMMUNICATION SYSTEM

(71) Applicant: SAMSUNG ELECTRONICS CO., LTD., Suwon-si, Gyeonggi-do (KR)

(72) Inventors: June HWANG, Suwon-si (KR); Anil AGIWAL, Suwon-si (KR); Hyunjeong KANG, Suwon-si (KR); Byounghoon JUNG, Suwon-si (KR)

(21) Appl. No.: 18/996,811

(22) PCT Filed: Jul. 11, 2023
(86) PCT No.: PCT/KR2023/009850

§ 371 Date: Jan. 17, 2025

(30) Foreign Application Priority Data
Jul. 21, 2022 (KR) 10-2022-0090239

(51) Int. Cl. H04W 74/0833; H04W 12/06; H04W 74/00; H04W 76/20

(52) U.S. Cl. CPC H04W 74/0833; H04W 12/06; H04W 74/002; H04W 76/20

(57) ABSTRACT

The present disclosure relates to: a communication technique for merging IoT technology with a 5G communication system for supporting a data transmission rate higher than that of a 4G system; and a system therefor. The present disclosure can be applied to intelligent services (for example, smart homes, smart buildings, smart cities, smart cars or connected cars, healthcare, digital education, retail businesses, security-and safety-related services, and the like) on the basis of 5G communication technology and IoT-related technology. The present disclosure provides an apparatus and a method related to a network-controlled repeater system.

### TECHNICAL FIELD

The disclosure relates to a network-controlled repeater system.

### BACKGROUND ART

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post long term evolution (LTE) System’. The 5G communication system is considered to be implemented in extremely high frequency (mm Wave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques have been discussed and adopted in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like. In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed. The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as sensing technology, wired/wireless communication and network infrastructure, service interface technology, and security technology have been required for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. The IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to the IoT network. For example, technologies such as a sensor network, machine type communication (MTC), and machine-to-machine (M2M) communication are being implemented on the basis of 5G communication technologies such as beamforming, MIMO, and an array antenna. The use of a cloud radio access network (cloud RAN) for big data processing technology is one example of convergence between the 5G technology and the IoT technology.

As various services have become available with the development of the mobile communication system as described above, schemes for effectively providing such services are required.

### DISCLOSURE OF INVENTION

### Technical Problem

The disclosure is intended to provide a method for a network-controlled repeater to perform network access and be configured with necessary operations.

In addition, the disclosure is intended to provide a device and method capable of effectively providing a service in a mobile communication system.

### Solution to Problem

According to an embodiment of the disclosure, a method of a terminal in a wireless communication system may include receiving system information from a base station; checking whether the system information includes an indicator indicating that a network-controlled repeater (NCR) is supported; and transmitting a random access preamble for a random access procedure to the base station, based on inclusion of the indicator in the system information, wherein the terminal may be a terminal that supports an NCR function.

In addition, according to an embodiment of the disclosure, a method of a base station in a wireless communication system may include generating an indicator indicating that a network-controlled repeater (NCR) is supported; broadcasting system information including the indicator; and receiving a random access preamble based on the system information from a terminal.

In addition, according to an embodiment of the disclosure, a terminal in a wireless communication system may include a transceiver; and a controller controlling the transceiver to receive system information from a base station, checking whether the system information includes an indicator indicating that a network-controlled repeater (NCR) is supported, and controlling the transceiver to transmit a random access preamble for a random access procedure to the base station, based on inclusion of the indicator in the system information, wherein the terminal may be a terminal that supports an NCR function.

In addition, according to an embodiment of the disclosure, a base station in a wireless communication system may include a transceiver; and a controller generating an indicator indicating that a network-controlled repeater (NCR) is supported, controlling the transceiver to broadcast system information including the indicator, and controlling the transceiver to receive a random access preamble based on the system information from a terminal.

### Advantageous Effects of Invention

According to an example of the disclosure, a specific method can be provided in which a network-controlled repeater attempts to access a base station and operates by receiving necessary configuration information from a network.

Specifically, according to an example of the disclosure, when a network-controlled repeater accesses a serving cell, the serving cell performs an operation of selectively allowing access after distinguishing between a cell in which the controlled repeater can be operated and a cell in which it cannot, and the controlled repeater performs an operation of notifying the cell that it is a network-controlled repeater after access. So, there is an effect that a signal for controlling the controlled repeater can be properly transmitted/received between the cell and the network-controlled repeater.

### BRIEF DESCRIPTION OF DRAWINGS

FIG. 1 is a diagram illustrating the structure of an LTE system according to an embodiment of the disclosure.

FIG. 2 is a diagram illustrating a radio protocol structure in an LTE system according to an embodiment of the disclosure.

FIG. 3 is a diagram illustrating the structure of a next-generation mobile communication system according to an embodiment of the disclosure.

FIG. 4 is a diagram illustrating a radio protocol structure of a next-generation mobile communication system according to an embodiment of the disclosure.

FIG. 5 is a block diagram illustrating the internal structure of a UE according to an embodiment of the disclosure.

FIG. 6 is a block diagram illustrating the configuration of a base station according to an embodiment of the disclosure.

FIG. 7 is a diagram illustrating the configuration of a network-controlled repeater according to an embodiment of the disclosure.

FIG. 8A is a flowchart of a method by which an NCR-MT notifies that it is an NCR entity by using an RRCSetupComplete message.

FIG. 8B is a flowchart of a method by which an NCR-MT notifies that it is an NCR entity by using an RRCSetupComplete message.

FIG. 9A is a flowchart of a method by which an NCR-MT notifies that it is an NCR entity by using an RRCSetupRequest message.

FIG. 9B is a flowchart of a method by which an NCR-MT notifies that it is an NCR entity by using an RRCSetupRequest message.

### MODE FOR THE INVENTION

Hereinafter, the operation principle of the disclosure will be described in detail in conjunction with the accompanying drawings. In the following description of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various kinds of identification information, etc. are illustratively used for the convenience of description. Therefore, the disclosure is not limited by the terms as used below, and other terms referring to subjects having equivalent technical meanings may be used.

Hereinafter, for the convenience of description, the disclosure will use terms and names defined in the 3rd generation partnership project long term evolution (3GPP LTE) standards. However, the disclosure is not limited by these terms and names, and may be applied in the same way to systems that conform other standards.

The advantages and features of the disclosure and the manner of achieving them will become apparent through embodiments described below with reference to the accompanying drawings. The disclosure may be, however, embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of the appended claims. Throughout the specification, the same reference numerals refer to the same constitutional elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card. Also, in embodiments, the unit may include one or more processors.

In the following description of the disclosure, if it is determined that a detailed description of a related known function or configuration may unnecessarily obscure the subject matter of the disclosure, the detailed description will be omitted. Hereinafter, an embodiment of the disclosure will be described with reference to the attached drawings. In the following description, terms for identifying access nodes, terms referring to network entities, terms referring to messages, terms referring to interfaces between network entities, terms referring to various kinds of identification information, etc. are illustratively used for the convenience of description. Therefore, the disclosure is not limited by the terms as used below, and other terms referring to subjects having equivalent technical meanings may be used. For example, in the description below, the term terminal may refer to a MAC entity within the terminal that exists in each of Master Cell Group (MCG) and Secondary Cell Group (SCG) described below.

Hereinafter, for the convenience of description, the disclosure will use terms and names defined in the 3rd generation partnership project long term evolution (3GPP LTE) standards. However, the disclosure is not limited by these terms and names, and may be applied in the same way to systems that conform other standards.

Hereinafter, a base station refer to an entity that performs resource allocation for a terminal, and may be at least one of gNode B (gNB), eNode B (eNB), Node B, a base station (BS), a radio access unit, a base station controller, or a node on a network. A terminal may include a user equipment (UE), a mobile station (MS), a cellular phone, a smart phone, a computer, or a multimedia system capable of performing a communication function. Of course, it is not limited to the above examples.

In particular, the disclosure can be applied to 3GPP NR (5th generation mobile communication standard). In addition, the disclosure can be applied to intelligent services (e.g., smart home, smart building, smart city, smart car or connected car, healthcare, digital education, retail, security and safety related services, etc.) based on the 5G communication technology and the IoT related technology. In the disclosure, eNB may be used interchangeably with gNB for convenience of explanation. That is, a base station described as eNB may represent gNB. In addition, the term terminal may represent a mobile phone, NB-IOT devices, sensors, and other wireless communication devices.

Outgrowing what provides an initial voice-oriented service, a wireless communication system is evolving to a broadband wireless communication system that provides a high-speed and high-quality packet data service, like communication standards such as, for example, 3GPP high speed packet access (HSPA), long term evolution (LTE) (or evolved universal terrestrial radio access (E-UTRA)), LTE-advanced (LTE-A), high rate packet data (HRPD) of 3GPP2, ultra-mobile broadband (UMB), and 802.16e of IEEE. In the LTE system, which is a representative example of the broadband wireless communication system, a downlink (DL) adopts an orthogonal frequency division multiplexing (OFDM) scheme, and an uplink (UL) adopts a single carrier frequency division multiple access (SC-FDMA) scheme. The uplink refers to a radio link in which a terminal (user equipment (UE) or mobile station (MS)) transmits data or control signals to a base station (eNode B or BS), and the downlink refers to a radio link in which a base station transmits data or control signals to a terminal. The multiple access scheme as mentioned above generally allocates and operates time-frequency resources, through which data or control information is to be transmitted, for each user so that they do not overlap each other, that is, orthogonality is established, and thereby the data or control information of each user is distinguished.

The 5G communication system, which is the communication system after the LTE, should be able to freely reflect various requirements of users and service providers, and should also support services that simultaneously satisfy various requirements. As services considered for the 5G communication system, there are enhanced mobile broadband (eMBB), massive machine type communication (mMTC), ultra-reliability low-latency communication (URLLC), and the like.

According to some embodiments, the eMBB aims to provide a more improved data transfer rate than the data transfer rate supported by the existing LTE, LTE-A, or LTE-Pro. For example, in the 5G communication system, the eMBB should be able to provide a peak data rate of 20 Gbps in the downlink and a peak data rate of 10 Gbps in the uplink from the viewpoint of one base station. Also, the 5G communication system is required to not only provide the peak data rate, but also provide an increased user-perceived data rate. In order to satisfy such requirements, it is required to improve various transmission/reception technologies including a more advanced multi-input multi-output (MIMO) transmission technology. In addition, the LTE transmits a signal using a transmission bandwidth of up to 20 MHz in the 2 GHz band, whereas the 5G communication system uses a frequency bandwidth wider than 20 MHz in the frequency band of 3 to 6 GHz or 6 GHz or more, thereby satisfying the required data rate.

At the same time, the mMTC is being considered to support application services such as the Internet of things (IoT) in the 5G communication system. In order to efficiently provide the IoT, the mMTC requires massive UE access support within a cell, improved UE coverage, improved battery life, reduced UE cost, and the like. Because the IoT is attached to a variety of sensors and devices to provide communication functions, a large number of UEs (e.g., 1,000,000 UEs/km²) should be supported within a cell. In addition, because a UE that supports the mMTC is highly likely to be located in a shaded area that a cell cannot cover, such as the basement of a building, due to the characteristics of the service, the mMTC may require wider coverage compared to other services provided by the 5G communication system. A UE that supports the mMTC should be implemented with low cost and may require a very long battery life time such as 10 to 15 years because it is difficult to frequently exchange the battery of the UE.

Finally, the URLLC is a cellular-based wireless communication service used for a specific purpose (mission-critical). For example, services used for remote control for a robot or machinery, industrial automation, unmanned aerial vehicle, remote health care, emergency alert, etc. may be considered. Thus, the communication provided by the URLLC should provide very low latency and very high reliability. For example, a service that supports the URLLC should satisfy an air interface latency of less than 0.5 milliseconds and also has a requirement of a packet error rate of 10-5 or less. Therefore, for a service that supports the URLLC, the 5G system should provide a smaller transmit time interval (TTI) than other services and may also require a design having to allocate a wide resource in a frequency band to ensure the reliability of a communication link. The three services considered in the aforementioned 5G communication system, that is, eMBB, URLLC, and mMTC, may be multiplexed and transmitted in one system. In this case, such services may use different transmission/reception techniques and parameters so as to satisfy different requirements of the respective services. However, the aforementioned mMTC, URLLC, and eMBB are only examples of different service types, and the service types to which the disclosure is applied are not limited to the aforementioned examples.

In addition, although embodiments of the disclosure are described below using LTE, LTE-A, LTE Pro, or 5G (or NR, next-generation mobile communication) systems as examples, the embodiments of the disclosure can be applied to other communication systems having similar technical backgrounds or channel types. Also, the embodiments of the disclosure can be applied to other communication systems through some modifications without significantly departing from the scope of the disclosure at the discretion of a person having skilled technical knowledge.

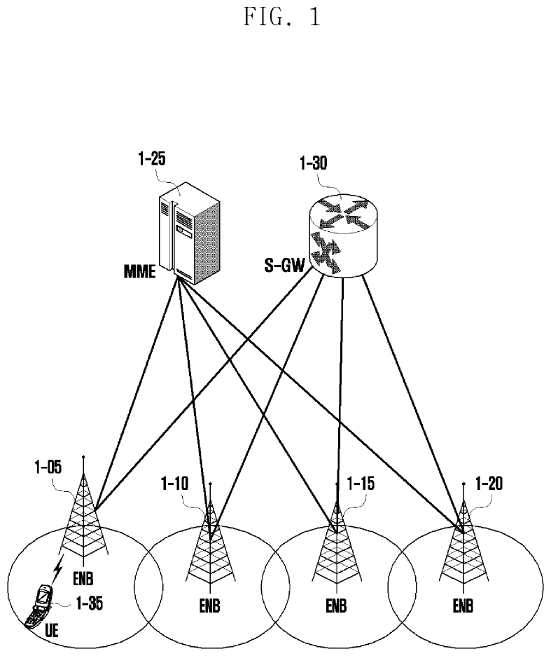

FIG. 1 is a diagram illustrating the structure of an LTE system according to an embodiment of the disclosure.

With reference to FIG. 1, a radio access network of the LTE system may include next-generation evolved node Bs (hereinafter, referred to as evolved node Bs (ENBs), Node Bs, or base stations) 1-05, 1-10, 1-15 and 1-20, a mobility management entity (MME) 1-25, and a serving-gateway (S-GW) 1-30. A user equipment 1-35 (hereinafter, referred to as a UE or a terminal) may access an external network through the eNBs 1-05 to 1-20 and the S-GW 1-30.

In FIG. 1, the ENBs 1-05 to 1-20 may correspond to conventional Node Bs of a universal mobile telecommunications system (UTMS). The ENB is connected to the UE 1-35 through a radio channel, and may perform a more complicated role than the conventional node B. In the LTE system, all user traffic including a real-time service such as a voice over IP (VoIP) through an Internet protocol are serviced through a shared channel. Thus, an apparatus for collecting and scheduling status information on buffer statuses of UEs, available transmission power status, and channel statuses is required, and the ENBs 1-05 to 1-20 may serve as this apparatus. In general, one ENB may control a plurality of cells. For example, in order to implement a transfer rate of 100 Mbps, the LTE system may use orthogonal frequency-division multiplexing (OFDM) as a radio access technology in a bandwidth of 20 MHz. Furthermore, the ENB may apply an adaptive modulation and coding (AMC) scheme of determining a modulation scheme and a channel-coding rate depending on the channel status of the UE. The S-GW 1-30 is an apparatus for providing a data bearer, and may generate or remove the data bearer under the control of the MME 1-25. The MME is an apparatus for performing not only a function of managing the mobility of the UE but also various control functions, and may be connected to the plurality of ENBs.

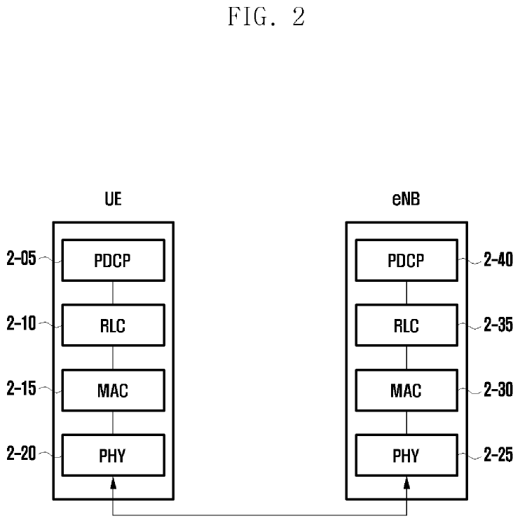

FIG. 2 is a diagram illustrating a radio protocol structure in an LTE system according to an embodiment of the disclosure.

With reference to FIG. 2, in each of the UE and the ENB, the radio protocol of the LTE system may include a packet data convergence protocol (PDCP) 2-05 or 2-40, a radio link control (RLC) 2-10 or 2-35, a medium access control (MAC) 2-15 or 2-30. The PDCP may perform an operation of compressing/decompressing an Internet protocol (IP) header. The main functions of the PDCP can be summarized as follows. Of course, it is not limited to the examples below.
Header compression and decompression function (Header compression and decompression: ROHC only)
User data transmission function (transfer of user data)
Sequential delivery function (in-sequence delivery of upper-layer PDUs at PDCP reestablishment procedure for RLC AM)
Sequence re-arrangement function (For split bearers in DC (only support for RLC AM): PDCP PDU routing for transmission and PDCP PDU reordering for reception)
Duplicate detection function (duplicate detection of lower-layer SDUs at PDCP reestablishment procedure for RLC AM)
Retransmission function (retransmission of PDCP SDUs at handover and, for split bearers in DC, of PDCP PDUs at PDCP data recovery procedure, for RLC AM)
Ciphering and deciphering function (Ciphering and deciphering)
Timer-based SDU removal function (timer-based SDU discard in uplink) According to an embodiment, the radio link control (RLC) 2-10 or 2-35 reconfigures the PDCP packet data unit (PDU) to be the proper size and performs an automatic repeat request (ARQ) operation, etc. The main functions of the RLC can be summarized as follows. Of course, it is not limited to the examples below.
Data transmission function (transfer of upper-layer PDUs)
ARQ function (Error Correction through ARQ (only for AM data transfer))
Concatenation, segmentation, and reassembly function (Concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplication detection function (duplicate detection (only for UM and AM data transfer))
Error detection function (protocol error detection (only for AM data transfer))
RLC SDU deletion function (RLC SDU discard (only for UM and AM data transfer))
RLC reestablishment function (RLC reestablishment)

According to an embodiment, the MAC 2-15 or 2-30 is connected with various RLC layer devices equipped in one UE, and performs an operation of multiplexing RLC PDUs to the MAC PDU and de-multiplexing the RLC PDUs from the MAC PDU. The main functions of the MAC can be summarized as follows. Of course, it is not limited to the examples below.
Mapping function (Mapping between logical channels and transport channels)
Multiplexing and demultiplexing function (Multiplexing/demultiplexing of MAC SDUs belonging to one or multiple different logical channels into/from transport blocks (TB) delivered to/from the physical layer on transport channels)
Scheduling information report function (scheduling information reporting)
HARQ (hybrid automatic repeat request) function (error correction through HARQ)
Logical channel priority control function (priority handling between logical channels of one UE)
UE priority control function (priority handling between UEs by means of dynamic scheduling)
MBMS service identification function (MBMS service identification)
Transport format selection function (transport format selection)
Padding function (padding)

According to an embodiment, the PHY layer 2-20 or 2-25 may perform an operation of channel-coding and modulating upper-layer data to generate an OFDM symbol and transmitting the generated OFDM symbol through a radio channel or demodulating and channel-decoding the OFDM symbol received through the radio channel and transmitting the demodulated and channel-decoded OFDM symbol to an upper layer.

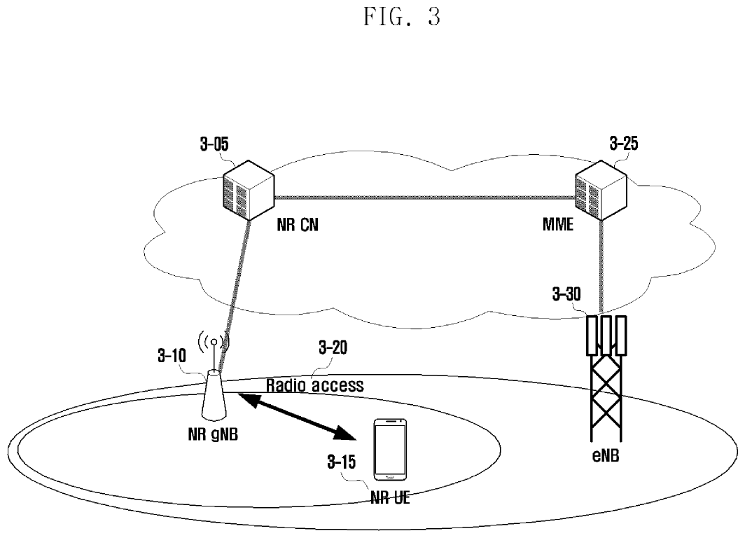

FIG. 3 is a diagram illustrating the structure of a next-generation mobile communication system according to an embodiment of the disclosure.

With reference to FIG. 3, a radio access network of the next-generation mobile communication system (hereinafter, referred to as NR or 5G) may include a next-generation base station 3-10 (new radio node B, hereinafter, referred to as an NR gNB or an NR base station) and a new radio core network (NR CN) 3-05. A user terminal 3-15 (hereinafter, referred to as a new radio user equipment (NR UE) or a terminal) may access an external network through the NR gNB 3-10 and the NR CN 3-05.

In FIG. 3, the NR gNB 3-10 may correspond to an evolved Node B (eNB) in a conventional LTE system. The NR gNB may be connected to the NR UE 3-15 through a radio channel and may provide better service than the conventional node B. All user traffic is served through a shared channel in the next-generation mobile communication system. Thus, an apparatus for collecting and scheduling status information of buffer statuses, available transmission power statuses, and channel statuses of UEs is required, and the NR gNB 3-10 can sever as this apparatus. One NR gNB 3-10 may control a plurality of cells. In the next-generation mobile communication system, bandwidths greater than the current maximum bandwidth may be applied to implement super-high-speed data transmission compared to the current LTE. Also, beamforming technology may be additionally used with orthogonal frequency division multiplexing (OFDM) as a radio access technology.

In addition, according to an embodiment, the NR gNB 3-10 may apply an adaptive modulation and coding (AMC) scheme of determining a modulation scheme and a channel-coding rate depending on the channel status of the NR UE. The NR CN 3-05 may perform functions of supporting mobility, configuring a bearer, configuring QoS, and the like. The NR CN 3-05 is an apparatus for performing a function of managing the mobility of the NR UE and various control functions, and may be connected to a plurality of base stations. Further, the next-generation mobile communication system may be interworked with the conventional LTE system, and the NR CN may be connected to an MME 3-25 through a network interface. The MME 3-25 may be connected to an eNB 3-30 which is the existing base station.

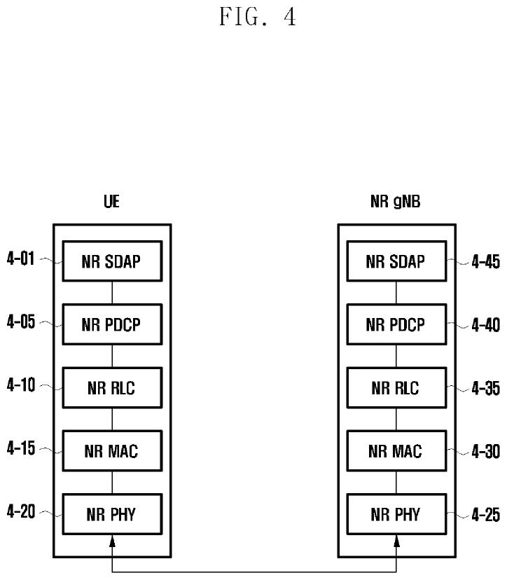

FIG. 4 is a diagram illustrating a radio protocol structure of a next-generation mobile communication system according to an embodiment of the disclosure.

With reference to FIG. 4, in each of the UE and the NR base station, the radio protocol of the next-generation mobile communication system may include an NR service data adaptation protocol (SDAP) 4-01 or 4-45, an NR PDCP 4-05 or 4-40, an NR RLC 4-10 or 4-35, and an NR MAC 4-15 or 4-30.

According to an embodiment, the main functions of the NR SDAP 4-01 or 4-45 may include some of the following functions. Of course, it is not limited to the examples below.
User data transmission function (transfer of user-plane data)
Function of mapping QoS flow and a data bearer for uplink and downlink (mapping between a QoS flow and a DRB for both DL and UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs)

For the SDAP layer device, the UE may be configured whether to use a header of the SDAP layer device or a function of the SDAP layer device per PDCP layer device, per bearer, or per logical channel through a radio resource control (RRC) message. If the SDAP header is configured, the SDAP layer device may instruct the UE to update or reconfigure mapping information for QoS flow and a data bearer in uplink and downlink by means of a 1-bit indicator of non-access stratum (NAS) reflective quality of service (QoS) of the SDAP header and a 1 bit-indicator of access stratum (AS) reflective QoS. According to an embodiment, the SDAP header may include QoS flow ID information indicating the QoS. According to an embodiment, the QoS information may be used as data processing priority, scheduling information, etc. to support a seamless service.

According to an embodiment, the main functions of the NR PDCP 4-05 or 4-40 may include some of the following functions. Of course, it is not limited to the examples below.
Header compression and decompression function (Header compression and decompression: ROHC only)
User data transmission function (transfer of user data)
Sequential delivery function (in-sequence delivery of upper-layer PDUs)
Non-sequential delivery function (out-of-sequence delivery of upper-layer PDUs)
Reordering function (PDCP PDU reordering for reception)
Duplicate detection function (duplicate detection of lower-layer SDUs)
Retransmission function (retransmission of PDCP SDUs)
Ciphering and deciphering function (Ciphering and deciphering)
Timer-based SDU removal function (timer-based SDU discard in uplink)

In the above description, the reordering function of the NR PDCP device may refer to a function of sequentially reordering PDCP PDUs received by a lower layer on the basis of a PDCP sequence number (SN). The reordering function of the NR PDCP device may include a function of sequentially transferring the reordered data to an upper layer, a function of directly transmitting the reordered data without regard to the order, a function of recording PDCP PDUs lost due to the reordering, a function of reporting statuses of the lost PDCP PDUs to a transmitting side, and a function of making a request for retransmitting the lost PDCP PDUs.

According to an embodiment, the main functions of the NR RLC 4-10 or 4-35 may include some of the following functions. Of course, it is not limited to the examples below.
Data transmission function (transfer of upper-layer PDUs)
Sequential delivery function (in-sequence delivery of upper-layer PDUs)
Non-sequential delivery function (out-of-sequence delivery of upper-layer PDUs)
ARQ function (error correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU deletion function (RLC SDU discard)
RLC reestablishment function (RLC reestablishment)

In the above description, the sequential delivery function (in-sequence delivery) of the NR RLC device may refer to a function of sequentially transferring RLC PDUs received from a lower layer to an upper layer. In the case where one original RLC SDU is divided into a plurality of RLC SDUs and then received, the sequential delivery function (in-sequence delivery) of the NR RLC device may include a function of reassembling and transmitting the RLC SDUs.

The sequential delivery function (in-sequence delivery) of the NR RLC device may include a function of reordering the received RLC PDUs on the basis of an RLC sequence number (SN) or a PDCP SN, a function of recording RLC PDUs lost due to the reordering, a function of reporting statuses of the lost RLC PDUs to a transmitting side, and a function of making a request for retransmitting the lost RLC PDUs.

The sequential delivery function (in-sequence delivery) of the NR RLC device may include, if there is a lost RLC SDU, a function of sequentially transferring only RLC SDUs preceding the lost RLC SDU to an upper layer.

The sequential delivery function (in-sequence delivery) of the NR RLC device may include, if there is a lost RLC SDU, but a specified timer has expired, a function of sequentially transferring all RLC SDUs, received before the timer starts, to an upper layer

The sequential delivery function (in-sequence delivery) of the NR RLC device may include, if there is a lost RLC SDU, but a specified timer has expired, a function of sequentially transferring all RLC SDUs, received up to the present, to an upper layer.

The NR RLC device may process the RLC PDUs sequentially in the order of reception thereof regardless of the order of sequence numbers (out-of-sequence delivery) and transfer them to the PDCP device.

In the case of receiving segments, the NR RLC device may receive segments that are stored in the buffer or are to be received in the future, reconfigure the segments to be one RLC PDU, and then transmit them to the NR PDCP device.

The NR RLC layer may not include a concatenation function, and the function may be performed by the NR MAC layer or replaced with a multiplexing function of the NR MAC layer.

In the above description, the non-sequential delivery function (out-of-sequence delivery) of the NR RLC device may refer to a function of transferring RLC SDUs, received from a lower layer, directly to an upper layer regardless of the order of the RLC SDUs. The non-sequential delivery function (out-of-sequence delivery) of the NR RLC device may include, when one original RLC SDU is divided into a plurality of RLC SDUs and then received, a function of reassembling and transmitting the RLC PDUs. The non-sequential delivery function (out-of-sequence delivery) of the NR RLC device may include a function of storing RLC SNs or PDCP SNs of the received RLC PDUs, reordering the RLC PDUs, and recording lost RLC PDUs.

According to an embodiment, the NR MAC 4-15 or 4-30 may be connected to a plurality of NR RLC layer devices equipped in one UE, and main functions of the NR MAC may include some of the following functions. Of course, it is not limited to the examples below.
Mapping function (Mapping between logical channels and transport channels)
Multiplexing and demultiplexing function (multiplexing/demultiplexing of MAC SDUs)
Scheduling information report function (scheduling information reporting)
HARQ function (error correction through HARQ)
Logical channel priority control function (priority handling between logical channels of one UE)
UE priority control function (priority handling between UEs by means of dynamic scheduling)
MBMS service identification function (MBMS service identification)
Transport format selection function (transport format selection)
Padding function (padding)

The NR PHY layer 4-20 or 4-25 may perform an operation of channel-coding and modulating upper layer data to generate an OFDM symbol and transmitting the generated OFDM symbol through a radio channel or demodulating and channel-decoding the OFDM symbol received through the radio channel and transmitting the demodulated and channel-decoded OFDM symbol to an upper layer.

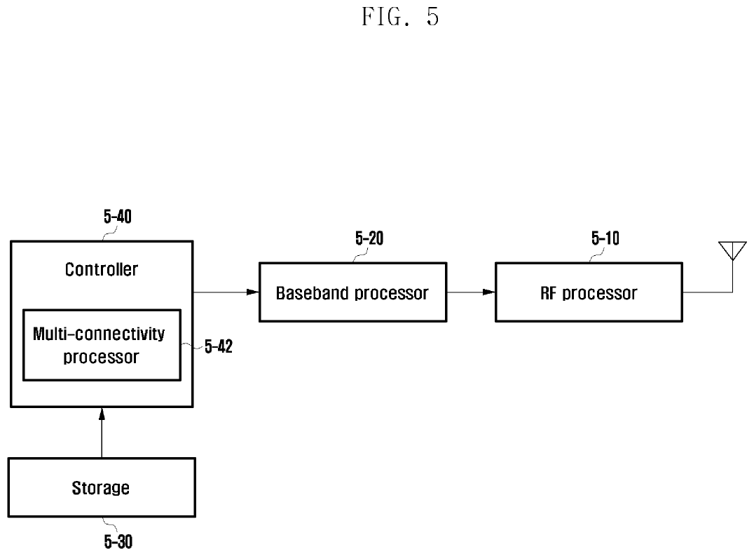

FIG. 5 is a block diagram illustrating the internal structure of a UE according to an embodiment of the disclosure.

With reference to FIG. 5, the UE may include a radio frequency (RF) processor 5-10, a baseband processor 5-20, a storage 5-30, and a controller 5-40. Of course, it is not limited to the above example, and the UE may include fewer or more components than those shown in FIG. 5.

The RF processor 5-10 may perform functions of transmitting and receiving signals via radio channels, such as band conversion and amplification of the signals. That is, the RF processor 5-10 may up-convert a baseband signal, provided from the baseband processor 5-20, into an RF band signal and then transmit the RF band signal via an antenna, and it may down-convert an RF band signal, received via the antenna, into a baseband signal. For example, the RF processor 5-10 may include a transmission filter, a reception filter, an amplifier, a mixer, an oscillator, a digital-to-analog convertor (DAC), an analog-to-digital convertor (ADC), or the like. Of course, it is not limited to the above example. Although only one antenna is illustrated in FIG. 5, the UE may include a plurality of antennas. Also, the RF processor 5-10 may include a plurality of RF chains. In addition, the RF processor 5-10 may perform beamforming. For beamforming, the RF processor 5-10 may respectively adjust phases and intensities of signals to be transmitted or received via a plurality of antennas or antenna elements. In addition, the RF processor 5-10 may perform a multi-input multi-output (MIMO) operation and may receive a plurality of layers in the MIMO operation.

The baseband processor 5-20 converts between a baseband signal and a bitstream based on physical layer specifications of a system. For example, upon data transmission, the baseband processor 5-20 generates complex symbols by encoding and modulating a transmission bitstream. Upon data reception, the baseband processor 5-20 reconstructs a received bitstream by demodulating and decoding a baseband signal provided from the RF processor 5-10. For example, in the case of complying with an orthogonal frequency division multiplexing (OFDM) scheme, upon data transmission, the baseband processor 5-20 generates complex symbols by encoding and modulating a transmission bitstream, maps the complex symbols to subcarriers, and then constructs OFDM symbols by performing inverse fast Fourier transform (IFFT) and cyclic prefix (CP) insertion. Upon data reception, the baseband processor 5-20 segments a baseband signal provided from the RF processor 5-10 into OFDM symbol units, reconstructs signals mapped to subcarriers by performing fast Fourier transform (FFT), and then reconstructs a received bitstream by demodulating and decoding the signals.

The baseband processor 5-20 and the RF processor 5-10 transmit and receive signals as described above. The baseband processor 5-20 and the RF processor 5-10 may be called a transmitter, a receiver, a transceiver, or a communicator. In addition, at least one of the baseband processor 5-20 or the RF processor 5-10 may include a plurality of communication modules to support a plurality of different radio access technologies. Also, at least one of the baseband processor 5-20 or the RF processor 5-10 may include different communication modules to process signals of different frequency bands. For example, the different radio access technologies may include wireless LAN (e.g., IEEE 802.11), cellular network (e.g., LTE), etc. Also, the different frequency bands may include a super-high frequency (SHF) (e.g., 2.NRHz, NRHz) band and a millimeter wave (mm Wave) (e.g., 60 GHz) band. The UE can transmit and receive signals to and from the base station using the baseband processor 5-20 and the RF processor 5-10, and the signals may include control information and data.

The storage 5-30 stores default programs, application programs, and data, such as configuration information, for operations of the UE. In particular, the storage 5-30 may store information related to an access node that performs wireless communication using a second radio access technology. In addition, the storage 5-30 provides the stored data upon request by the controller 5-40. The storage 5-30 may be composed of a storage medium such as a ROM, a RAM, a hard disk, a CD-ROM, and a DVD, or a combination of storage media. Also, the storage 5-30 may be composed of a plurality of memories. The controller 5-40 controls overall operations of the UE. For example, the controller 5-40 transmits and receives signals through the baseband processor 5-20 and the RF processor 5-10. In addition, the controller 5-40 records and reads data on or from the storage 5-30. To this end, the controller 5-40 may include at least one processor. For example, the controller 5-40 may include a communication processor (CP) for controlling communications and an application processor (AP) for controlling an upper layer such as an application program. Additionally, at least one component within the UE may be implemented as one chip.

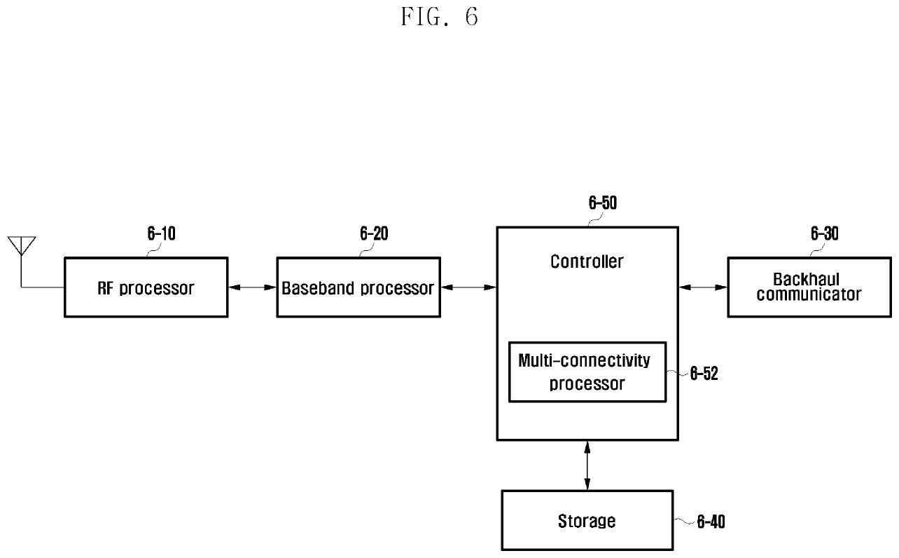

FIG. 6 is a block diagram illustrating the configuration of a base station according to an embodiment of the disclosure.

With reference to FIG. 6, the base station may include a RF processor 6-10, a baseband processor 6-20, a backhaul communicator 6-30, a storage 6-40, and a controller 6-50. Of course, it is not limited to the above example, and the base station may include fewer or more components than those shown in FIG. 6.

The RF processor 6-10 may perform functions of transmitting and receiving signals via radio channels, such as band conversion and amplification of the signals. That is, the RF processor 6-10 up-converts a baseband signal, provided from the baseband processor 6-20, into an RF band signal and then transmits the RF band signal via an antenna, and it down-converts an RF band signal, received via an antenna, into a baseband signal. For example, the RF processor 6-10 may include a transmission filter, a reception filter, an amplifier, a mixer, an oscillator, a DAC, an ADC, or the like. Although only one antenna is illustrated in FIG. 6, the RF processor 6-10 may include a plurality of antennas. Also, the RF processor 6-10 may include a plurality of RF chains. In addition, the RF processor 6-10 may perform beamforming. For beamforming, the RF processor 6-10 may respectively adjust phases and intensities of signals to be transmitted or received via a plurality of antennas or antenna elements. The RF processor may perform a downlink MIMO operation by transmitting one or more layers.

The baseband processor 6-20 converts between a baseband signal and a bitstream based on physical layer specifications of a first radio access technology. For example, upon data transmission, the baseband processor 6-20 generates complex symbols by encoding and modulating a transmission bitstream. Also, upon data reception, the baseband processor 6-20 reconstructs a received bitstream by demodulating and decoding a baseband signal provided from the RF processor 6-10. For example, in the case of complying with the OFDM scheme, upon data transmission, the baseband processor 6-20 generates complex symbols by encoding and modulating a transmission bitstream, maps the complex symbols to subcarriers, and then constructs OFDM symbols by performing IFFT and CP insertion. Upon data reception, the baseband processor 6-20 segments a baseband signal provided from the RF processor 6-10 into OFDM symbol units, reconstructs signals mapped to subcarriers by performing FFT, and then reconstructs a received bitstream by demodulating and decoding the signals. The baseband processor 6-20 and the RF processor 6-10 transmit and receive signals as described above. The baseband processor 6-20 and the RF processor 6-10 may be called a transmitter, a receiver, a transceiver, a communicator, or a wireless communicator. The base station can transmit and receive signals to and from the UE using the baseband processor 6-20 and the RF processor 6-10, and the signals may include control information and data.

The backhaul communicator 6-30 provides an interface for communicating with other nodes in the network. That is, the backhaul communicator 6-30 converts a bitstream transmitted from a main base station to any other node, for example, an auxiliary base station, a core network, etc., into physical signals, and converts physical signals received from such other node into a bitstream.

The storage 6-40 stores default programs, application programs, and data, such as configuration information, for operations of the base station. In particular, the storage 6-40 may store, for example, information about bearers assigned for a connected UE, measurement results reported from the connected UE, and the like. Also, the storage 6-40 may store criteria information used to determine whether to provide or release dual connectivity to or from the UE. In addition, the storage 6-40 provides the stored data upon request by the controller 6-50. The storage 6-40 may be composed of a storage medium such as a ROM, a RAM, a hard disk, a CD-ROM, and a DVD, or a combination of storage media. Also, the storage 6-40 may be composed of a plurality of memories. According to some embodiment, the storage 6-40 may store a program for performing a buffer status reporting method according to the disclosure.

The controller 6-50 may control overall operations of the base station. For example, the controller 6-50 transmits and receives signals through the baseband processor 6-20 and the RF processor 6-10 or through the backhaul communicator 6-30. Also, the controller 6-50 records and reads data on or from the storage 6-40. To this end, the controller 6-50 may include at least one processor. Additionally, at least one component of the base station may be implemented as one chip.

In the disclosure, a network-controlled repeater (NCR) is referred to as a single entity, and in terms of operation, one NCR is distinctively referred to as NCR-MT (mobile termination) and NCR-FWD (forwarding).

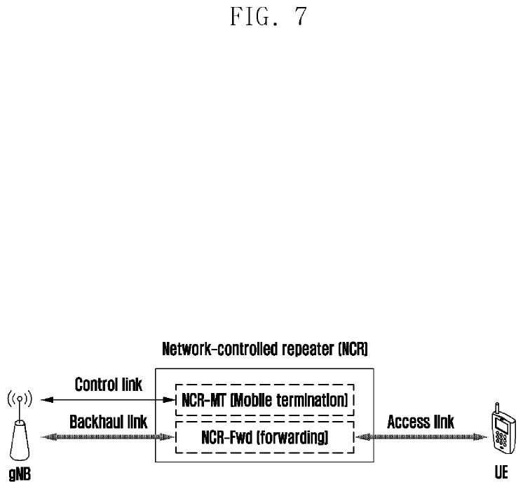

FIG. 7 is a diagram illustrating the configuration of a network-controlled repeater according to an embodiment of the disclosure.

The network-controlled repeater (NCR) is composed of the NCR-MT and the NCR-FWD. MT is an abbreviation for mobile termination, and the NCR-MT can receive a control signal for NCR operation from a serving gNB and transmit control information to the NCR-FWD. FWD is an abbreviation for forwarding, and the NCR-FWD amplifies an RF signal received from a gNB and transmits it to a UE. The NCR-FWD may perform additional operations through the control information received from the NCR-MT. For example, the NCR-FWD may transmit an amplified signal to the UE by using a specific beam or receive a signal transmitted by the UE. In addition, for example, the NCR-FWD may receive/amplify/transmit a signal from the gNB according to a specific time division duplex (TDD) pattern, or perform or not perform receiving/amplifying/transmitting a signal from the UE.

In order to perform the above operations, the NCR and the network should be able to distinguish each other. Hereinafter, a method for the NCR and the network, i.e., the serving gNB, to distinguish each other and a method for exchanging configuration information specific to the NCR accordingly will be described.

The cell may include a separate cell for controlling the NCR. The NCR may perform operations required when accessing the separate cell and, for this purpose, receive control information from the separate cell. The separate cell needs to provide an indicator indicating that it is a cell for NCR uses, and the NCR, which has identified the cell for NCR uses, may continue to attempt to access the separate cell. For example, the serving gNB is capable of supporting a general UE, and may be a gNB that supports both the general UE and the NCR at the same time or a gNB that cannot support both the general UE and the NCR at the same time. According to an example, it may be divided into the following cases.

The gNB that supports the NCR or the NCR function may include an NCR-support indicator in a master information block (MIB) or a system information block (SIB) and broadcast it.

In another example, the gNB may introduce an intraFreqReselection-NCR bit (IFR bit) in the SIB. This bit may have a value of allowed or not-allowed. The presence of this bit may mean that this cell supports the NCR. After cell selection/reselection, if this bit is included in the SIB, the NCR-MT may attempt to access the cell by performing random access. If this bit does not exist in the SIB of the cell during cell selection/reselection, the NCR-MT may regard this cell as barred, regard the intraFreqReselection-NCR bit as configured to allowed, and select/reselect another cell having the same frequency as the barred cell when selecting/reselecting another cell. In a more specific example, if this bit exists in the SIB and its value is not-allowed, the NCR-MT may attempt to access this cell, and if this cell is barred during the access attempt, it must consider selecting/reselecting a cell of a frequency other than that of the barred cell. In other words, the corresponding frequency is also considered barred. On the other hand, if this bit exists in the SIB and its value is allowed, the NCR-MT may attempt to access this cell, and if this cell is barred during the access attempt, it may consider a cell of the same frequency as that of the barred cell when selecting/reselecting the cell.

The NCR-MT may selectively attempt to access an NCR-supported cell in the cell selection/reselection process in the above manner. If there is a process of establishing an RRC connection thereafter, the NCR-MT should notify the cell that it is an NCR entity or an NCR-MT. This method is as follows:
Case 1: Method of notifying in a random access channel (RACH) preamble transmission process.

The NCR-MT may be configured in advance with dedicated random access preamble and/or rach occasion (RO) and/or RACH resources. Alternatively, the NCR-MT may receive RACH related configuration from MIB or SIB of the cell which it attempts to access. After cell selection/reselection, the NCR-MT may attempt random access to access the cell. In this process, if RACH is attempted using NCR dedicated RACH preamble/RO/resources, the base station (gNB) may identify that the UE attempting the access is the NCR, and then the gNB may transmit control information for the NCR-FWD through the NCR-MT.
Case 2: Method of notifying in the remaining RACH process In the RACH process, message (MSG) 3 in the case of 4-step RACH or MSG A in the case of 2-step RACH may include an NCR-specialized logical channel ID (LCID). This LCID is an LCID for distinguishing a common control channel (CCCH) included in the corresponding MSG 3 or MSG A MAC PDU, and this LCID may be included in a MAC subheader in the MAC PDU. In this case, a UL CCCH may be, for example, RRCSetupRequest. According to this method, the gNB that successfully receives the MSG 3 or MSG A recognizes that the corresponding UE is the NCR based on this. Thereafter, the gNB may transmit control information for the NCR-FWD through the NCR-MT.

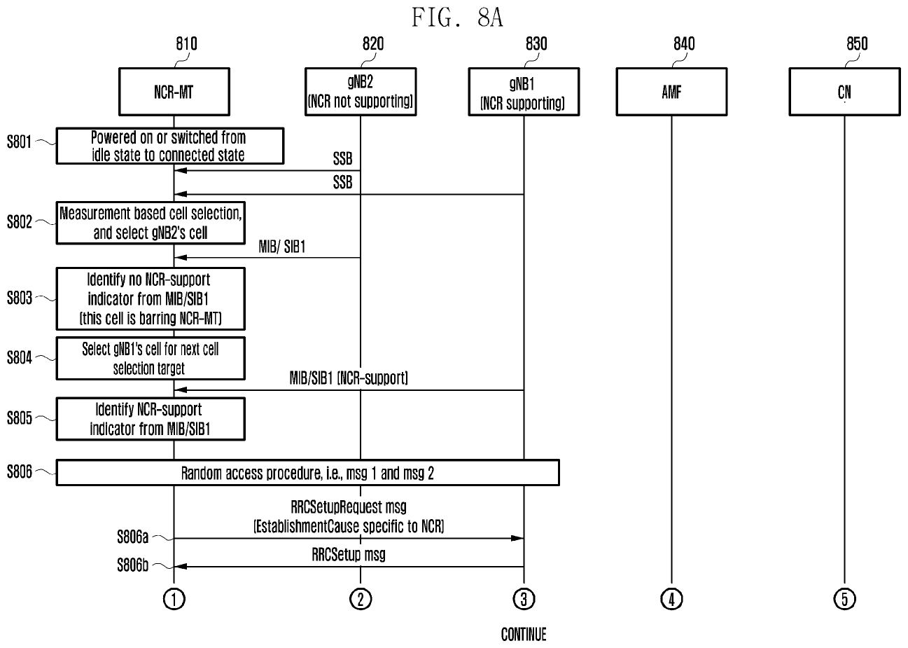

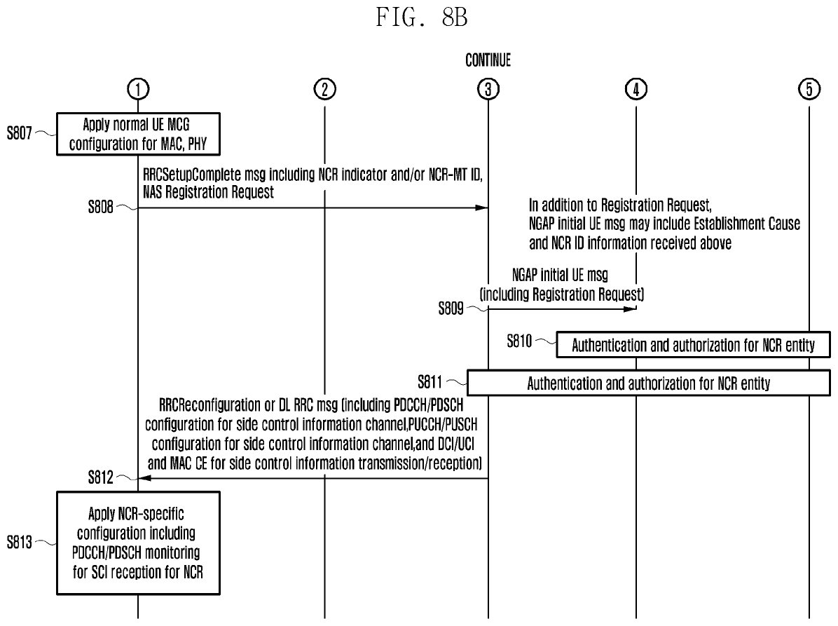

Case 3: Method of notifying in RRC connection setup process after RACH success Case 3-1: Method of notifying with RRCSetupComplete message In the case of receiving an uplink (UL) grant with the success of RACH procedure after cell selection/reselection, the NCR-MT transmits MSG 3 to the serving gNB through the RRCSetupRequest message, and if the serving gNB transmits the RRCSetup message, the NCR-MT applies this configuration and transmits the RRCSetupComplete message to the serving gNB. At this time, the RRCSetupComplete message may be transmitted by including an indicator indicating the NCR. The following detailed flow may correspond to the procedure shown in FIGS. 8A and 8B. In this example, including an NCR-support bit in MIB/SIB is exemplified, but a method utilizing an intra-Frequency Reselection bit is also possible.

FIGS. 8A and 8B are flowcharts of a method by which an NCR-MT notifies that it is an NCR entity by using an RRCSetupComplete message.

With reference to FIG. 8A, in S801, the NCR-MT 810 may be switched from an idle state to a connected state or powered on.

In step S802, upon receiving synchronization signal blocks (SSBs) transmitted from surrounding cells (e.g., base station 1 (gNB1, 830) and base station 2 (gNB2, 820) as shown in FIG. 8A), the NCR-MT 810 derives the signal strength of the cells, and selects a cell satisfying a cell selection condition based on this measurement. Here, it is assumed that the cell selected by the NCT-MT 810 is the cell of the gNB2 820.

Then, if receiving MIB or SIB1 of the selected cell and identifying that the cell is not an NCR-support cell, the NCR-MT 810 assumes a cell barred state in S803, performs cell selection on another cell (e.g., the cell of gNB1 830) in S804, and receives MIB/SIB1 of that cell to identify whether it is an NCR-support cell in S805.

Upon identifying that the cell is the NCR-support cell, the NCR-MT 810 may perform a random access procedure to the cell in S806. For example, in this procedure, the NCR-MT 810 may transmit MSG 3 to the cell 830 through the RRCSetupRequest message in S806a, and receive the RRCsetup message as response from the cell 830 in S806b.

At this time, the RRCSetupRequest message may include information about a connection establishment cause (EstablishmentCause) specific to the NCR.

The NCR-MT 810 that has received the RRCSetup message may apply a master cell group (MCG) configuration for the MAC and PHY acquired from the corresponding cell 830 based on this in S807 as in FIG. 8B. In addition, the NCR-MT 810 may transmit the RRCSetupComplete message to the corresponding cell to complete the RRC connection setup in S808. Here, the RRCSetupComplete message may include at least one of an indicator indicating that the NCR-MT 810 is an NCR, an NCR-MT ID, or a NAS registration request.

Meanwhile, the following specific operations/contents may be applied to the above-described procedures and the procedures to be described later.

1) gNB supporting NCR broadcasts the NCR-support indication in MIB or SIB. 2) When UE which is NCR-MT is powered on (or UE is in Idle/inactive), it can first search frequency to camp and select the cell based on measurement result (i.e., do legacy cell (re)selection procedure). 3) If the above selected cell is providing or broadcasting NCR-support bit in MIB or SIB, UE (NCR-MT), then finally select the cell to set RRC connection up with. A>NCR-MT applies the configurations in MIB and SIB1 of the selected cell. B>When NCR-MT tries to setup RRC connection, NCR-MT does random access procedure with gNB. NCR-MT sends RRCSetupRequest msg to gNB, and gNB responds with RRCSetup msg to NCR-MT. Within RRCSetupRequest msg, there is new cause value for Establishment indicating NCR control traffic. After NCR-MT configures the received RRCsetup msg, UE can add NCR-MT indication within RRCSetupComplete message and transmit it upon successful RRC setup procedure.
i. with or without above NCR-MT indication, RRCSetupComplete msg can also include: NCR specific entity ID (and/or (MT) ID, and/or FWD ID) either in legacy NAS msg ‘Registration Request’or out, and transfer this. C>Serving gNB identifies that the accessed UE is NCR-MT, and some UE ID visible in CN can be transferred to CN for authorization (like 5G TMSI or 5G-GUTI, or NCR-FWD ID).
i. NCR-FWD ID is transferred to CN within IE ‘NCR’, then CN can identify NCR-FWD. 4) Else UE (NCR-MT) considers the cell as barred.

A>for the frequency of this barred cell:
i. bar the frequency as well
ii. (assuming that NCR-MT does not ignore the other cell reservation bits including IFRI bit in MIB) bar the frequency if IFRI bit in MIB is set to not-Allowed. Otherwise, do not bar the frequency
iii. do not bar the frequency

With reference to FIG. 8B again, after the serving gNB 830 establishes the RRC connection with the NCR-MT 810 in S808, it can transmit a Registration Request to the AMF 840 by using an NGAP initial UE message. At this time, the NGAP initial UE message may include an Establishment cause indicating that it is an RRC connection indicator for NCR control, obtained during the RRC connection process. In addition, an ID of the NCR-MT or NCR entity, or an NCR-Fwd ID may be included in this message. This information may be transmitted from the serving gNB 830 to the AMF 840 in S809, and may be used for authorization and authentication of the NCR entity by the core network 850 in S810 and S811.

Specifically, whether the UE is authorized as an NCR node can be confirmed by the AMF 840, upon receiving the indicator (e.g., the UE ID of the NCR MT) for identifying the UE as the NCR node through the Initial UE message from the serving gNB 830, transmitting the indicator to a separate server on the core network 850 that holds the ID or a server 850 co-located with the AMF 840. If it is confirmed that the UE is authorized as the NCR node, the separate server on the core network 850 or the server 850 co-located with the AMF 840 can transmit to the AMF 840 an indication that the UE has been authorized. Upon receiving this, the AMF 840 can provide the serving gNB 830 with the indication that the UE has been authorized through an initial UE context setup request message. The above-described NCR authorization confirmation operation of the AMF and the co-located server may be replaced by the implementation of the AMF.

After receiving information related to authorization and authentication of the NCR entity, the serving gNB 830 may transmit control information for the operation of NCR-Fwd to the NCR-MT 810. The configuration information of L1/L2 channel for transmitting this control information may be transmitted to the NCR-MT 810 through a DL RRC message or an RRCReconfiguration message in S812. Detailed configurations transmitted at this time may be as follows.

NCR specific configurations i.e., PDCCH/PDSCH configuration for side control information channel, PUCCH/PUSCH configuration for side control information channel, configuration for DCI/UCI and MAC CE for side control information reception and transmission.

The NCR-MT 810 may apply the above configurations to receive side control information for NCR-Fwd from the serving gNB 830 through L1/L2 control signals in S813.

Case 3-2: Method of notifying with RRCSetupRequest message

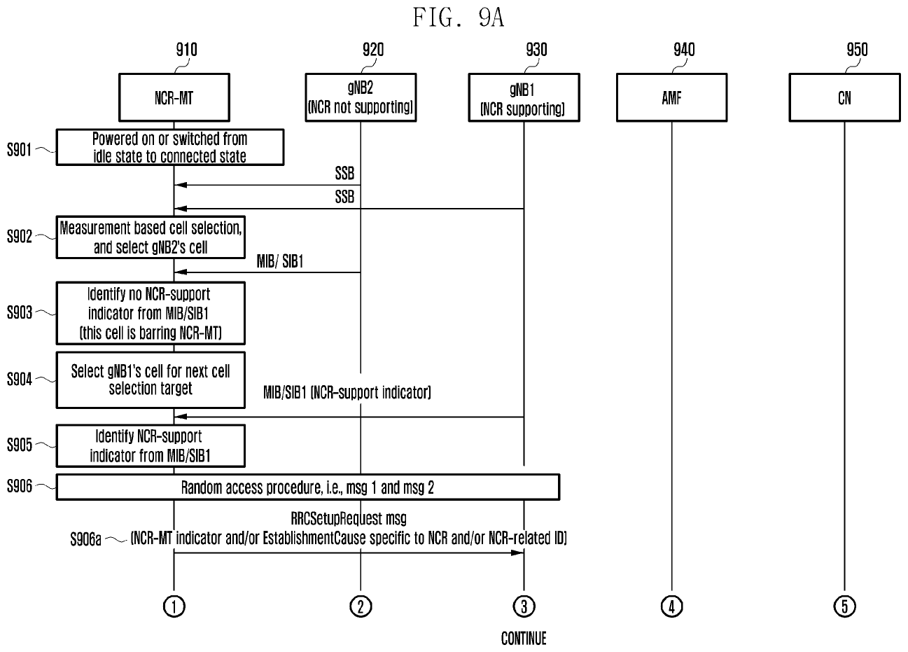

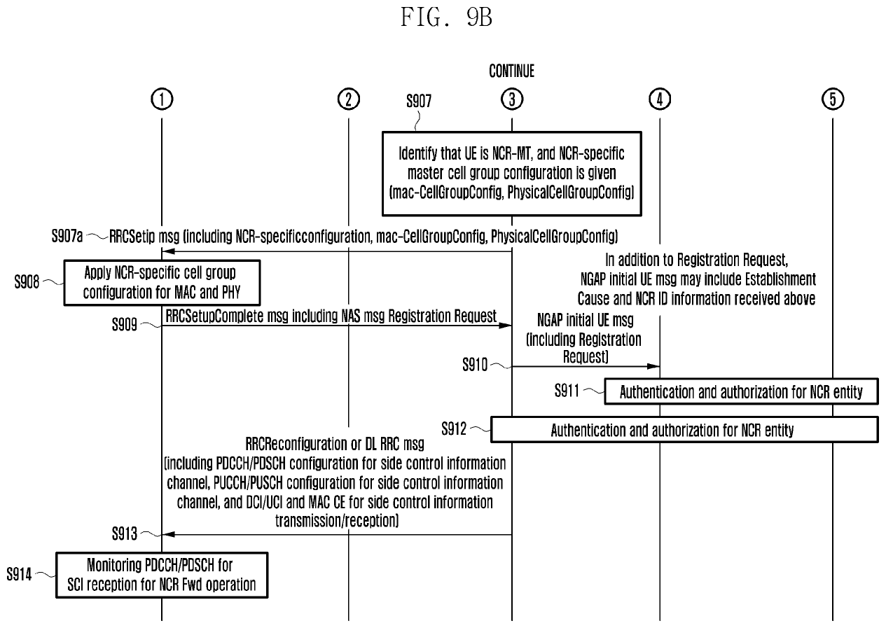

In the case of receiving the UL grant with the success of RACH procedure after cell selection/reselection, the NCR-MT transmits MSG 3 to the serving gNB through the RRCSetupRequest message, and if the serving gNB transmits the RRCSetup message, the NCR-MT applies this configuration and transmits the RRCSetupComplete message to the serving gNB. At this time, the RRCSetupRequest message may be transmitted by including an indicator indicating the NCR. The following detailed flow may correspond to the procedure shown in FIGS. 9A and 9B. In this example, the case where an NCR-support bit is included in MIB/SIB is described, but a method utilizing an intra-Frequency Reselection bit is also possible.

FIGS. 9A and 9B are flowcharts of a method by which an NCR-MT notifies that it is an NCR entity by using an RRCSetupRequest message.

With reference to FIG. 9A, in S901, the NCR-MT 910 may be switched from an idle state to a connected state or powered on.

In step S902, upon receiving SSBs transmitted from surrounding cells (e.g., base station 1 (gNB1, 930) and base station 2 (gNB2, 920) as shown in FIG. 9A), the NCR-MT 910 derives the signal strength of the cells, and selects a cell satisfying a cell selection condition based on this measurement. Here, it is assumed that the cell selected by the NCT-MT 910 is the cell of the gNB2 920.

Then, if receiving MIB or SIB1 of the selected cell and identifying that the cell is not an NCR-support cell, the NCR-MT 910 assumes a cell barred state in S903, performs cell selection on another cell (e.g., the cell of gNB1 930) in S904, and receives MIB/SIB1 of that cell to identify whether it is an NCR-support cell in S905. For example, the MIB/SIB1 may include an NCR-support indicator indicating that the cell supports NCR.

Upon identifying that the cell is the NCR-support cell, the NCR-MT 910 may perform a random access procedure to the cell in S906. For example, in this procedure, the NCR-MT 910 may transmit MSG 3 to the cell 930 through the RRCSetupRequest message in S906a, and at this time, the RRCSetupRequest message may include an NCR-MT indicator indicating the NCR-MT, a connection establishment cause (EstablishmentCause) specific to the NCR, and/or an NCR-related ID.

Meanwhile, the following specific operations/contents may be applied to the above-described procedures and the procedures to be described later.
1) gNB supporting NCR broadcasts the NCR-support indication in MIB or SIB.
2) When UE which is NCR-MT is powered on (or UE is in Idle/inactive), it can first search frequency to camp and select the cell based on measurement result (i.e., do legacy cell (re)selection procedure).
3) If the above selected cell is providing or broadcasting NCR-support bit in MIB or SIB, UE (NCR-MT), then finally select the cell to set RRC connection up with.

A>NCR-MT applies the configurations in MIB and SIB1 of the selected cell B>When NCR-MT tries to setup RRC connection, UE can add 1-bit indication to indicate NCR-MT or NCR entity within RRCSetupRequest msg and transmit it upon obtaining UL grant.
i. with or without above NCR-MT indication, in RRCSetupRequest msg, legacy ‘InitialUE-Identity’ field can indicate NCR specific UE ID, or NCR specific UE ID can be further indicated in separate IE than ‘initialUE-Identity’ field.
ii. Independent with above indication, in RRCSetupRequest msg, ‘EstablishmentCause’ can further indicate ‘NCR MT access’ value
C>Upon receiving above RRCSetupRequest msg, Serving gNB identifies that the accessed UE is NCR-MT, and select the radio resource and schedule the resource accordingly for NCR MT (frequency/time domain resource assignment, MCS selection etc.) via PDCCH
D>serving gNB setup SRB1 and send RRCSetup msg to NCR-MT.
E>UE (NCR-MT) applies the received RRCSetup configuration, and generates RRCSetupComplete msg which can include: NCR specific entity ID (and/or UE ID, and/or FWD ID) either in legacy NAS msg ‘Registration Request’ or out, and transmit this.
4) Else UE (NCR-MT) considers the cell as barred.

A>for the frequency of this barred cell:
i. bar the frequency as well
ii. (assuming that NCR-MT does not ignore the other cell reservation bits including IFRI bit in MIB) bar the frequency if IFRI bit in MIB is set to not-Allowed. Otherwise, do not bar the frequency
iii. do not bar the frequency

With reference to FIG. 9B, the serving gNB 930 can confirm that the accessed UE is an NCR-MT, based on the information received from the NCR-MT 910, and provide NCR-specific master cell group configuration (e.g., mac-CellGroupConfig, PhysicalCellGroupConfig) in S907. This configuration can be transmitted to the NCR-MT 910 through an RRCSetup message S907a. The NCR-MT 910 that receives the NCR-specific cell group configuration for the MAC layer or PHY layer from the serving gNB 930 can apply the corresponding cell group configuration in S908.

In addition, the NCR-MT 910 can transmit a NAS message including registration request to the serving gNB 930 through an RRCSetupComplete message in S909. After establishing the RRC connection with the NCR-MT 910, the serving gNB 930 can transmit the Registration Request to the AMF 940 by using an NGAP initial UE message in S910. At this time, the NGAP initial UE message may include an Establishment cause indicating that it is an RRC connection indicator for NCR control, acquired in the RRC connection process. In addition, an ID of the NCR-MT or NCR entity, or an NCR-Fwd ID may be included in this message. This information may be transmitted from the serving gNB 930 to the AMF 940 and used for authorization and authentication of the NCR entity by the core network 950 in S911 and S912. Here, the authentication procedure between the AMF 940 and the core network 950 is the same as described above in FIGS. 8A and 8B.

After receiving information related to authorization and authentication of the NCR entity, the serving gNB 930 may transmit control information for the operation of NCR-Fwd to the NCR-MT 910. The configuration information of L1/L2 channel for transmitting this control information may be transmitted to the NCR-MT 910 through a DL RRC message or an RRCReconfiguration message in S913. Detailed configurations transmitted at this time may be as follows.

NCR specific configurations i.e., PDCCH/PDSCH configuration for side control information channel, PUCCH/PUSCH configuration for side control information channel, configuration for DCI/UCI and MAC CE for side control information reception and transmission.

The NCR-MT 910 may apply the above configurations to receive side control information for NCR-Fwd from the serving gNB 930 through L1/L2 control signals in S914.

Meanwhile, embodiments of the disclosure and the accompanying drawings are only examples presented in order to easily describe the disclosure and facilitate comprehension of the disclosure, but are not intended to limit the scope of the disclosure. That is, it is apparent to a person skilled in the art that other modifications based on technical ideas of the disclosure can be implemented. In addition, the above-described embodiments may be used in combination with each other as needed. For example, one embodiment and another embodiment of the disclosure may be combined in part with each other to operate a base station and a terminal. Also, embodiments of the disclosure are applicable to other communication systems, and other modifications based on the technical ideas of the embodiments may also be implemented. For example, the embodiments may be applied to the LTE system, the 5G, NR system, the 6G systems, etc. Therefore, the scope of the disclosure should not be limited to the described embodiments, but should be defined not only by the scope of appended claims below but also by equivalents thereof.

1-14. (canceled)

15. A method performed by a terminal in a wireless communication system, the method comprising:
receiving, from a base station, a system information block (SIB);
identifying whether network-controlled repeater (NCR)-support information is included in the SIB, the NCR-support information indicating that a cell of the base station supports an NCR; and
in case that the NCR-support information is included in the SIB, transmitting, to the base station, a random access preamble for a connection,
wherein the terminal is an NCR-mobile termination (NCR-MT), the NCR-MT supporting to receive control information from the base station.

16. The method of claim 15, further comprising:
receiving, from the base station, a random access response for the random access preamble;
transmitting, to the base station, a radio resource control (RRC) setup request message, based on an uplink grant included in the random access response;
receiving, from the base station, an RRC setup message as a response to the RRC setup request message; and
transmitting, to the base station, an RRC setup complete message, based on the RRC setup message,
wherein the RRC setup complete message includes an indication indicating that the connection is associated with an NCR-node.

17. The method of claim 15, further comprising:
in case that the NCR-support information is not included in the SIB, considering the cell as barred for the NCR.

18. A method performed by a base station in a wireless communication system, the method comprising:
generating network-controlled repeater (NCR)-support information indicating that a cell of the base station supports an NCR;
broadcasting a system information block (SIB) including the NCR-support information; and
receiving, from a terminal, a random access preamble for a connection based on the SIB.

19. The method of claim 18, further comprising:
transmitting, to the terminal, a random access response for the random access preamble;
receiving, from the terminal, a radio resource control (RRC) setup request message, based on an uplink grant included in the random access response;
transmitting, to the terminal, an RRC setup message as a response to the RRC setup request message; and
receiving, from the terminal, an RRC setup complete message, based on the RRC setup message,
wherein the RRC setup complete message includes an indication indicating that the connection is associated with an NCR node.

20. The method of claim 19, further comprising:
transmitting, to an access and mobility management function (AMF), an initial user equipment (UE) message for requesting a registration of the terminal, after the RRC setup complete message is received; and
receiving, from an access and mobility management function (AMF), an initial UE context setup request message including NCR authentication information for the terminal, the NCR authentication information for the terminal indicating that the terminal is authorized as the NCR.

21. The method of claim 20, wherein the NCR authentication information for the terminal is used for configuring information for the terminal.

22. A terminal in a wireless communication system, the terminal comprising:
a transceiver; and
a controller configured to:
control the transceiver to receive, from a base station, a system information block (SIB),
identify whether network-controlled repeater (NCR)-support information is included in the SIB, the NCR-support information indicating that a cell of the base station supports an NCR, and
in case that the NCR-support information is included in the SIB, control the transceiver to transmit, to the base station a random access preamble for a connection,
wherein the terminal is an NCR-mobile termination (NCR-MT), the NCR-MT supporting to receive control information from the base station.

23. The terminal of claim 22,
wherein the controller is further configured to:
control the transceiver to receive, from the base station, a random access response for the random access preamble;
control the transceiver to transmit, to the base station, a radio resource control (RRC) setup request message, based on an uplink grant included in the random access response;
control the transceiver to receive, from the base station, an RRC setup message as a response to the RRC setup request message; and
control the transceiver to transmit, to the base station, an RRC setup complete message, based on the RRC setup message, and
wherein the RRC setup complete message includes an indication indicating that the connection is associated with an NCR-node.

24. The terminal of claim 22, wherein the controller is further configured to consider the cell as barred for the NCR, in case that the NCR-support information is not included in the SIB.

25. A base station in a wireless communication system, the base station comprising:
a transceiver; and
a controller configured to:
generate network-controlled repeater (NCR)-support information indicating that a cell of the base station supports an NCR,
control the transceiver to broadcast a system information block (SIB) including the NCR-support information, and
control the transceiver to receive, from a terminal, a random access preamble for a connection based on the SIB.

26. The base station of claim 25,
wherein the controller is further configured to:
control the transceiver to transmit, to the terminal, a random access response for the random access preamble;
control the transceiver to receive, from the terminal, a radio resource control (RRC) setup request message, based on an uplink grant included in the random access response,
control the transceiver to transmit, to the terminal, an RRC setup message as a response to the RRC setup request message, and
control the transceiver to receive, from the terminal, an RRC setup complete message, based on the RRC setup message, and
wherein the RRC setup complete message includes an indication indicating that the connection is associated with an NCR node.

27. The base station of claim 26,
wherein the controller is further configured to control the transceiver to transmit, to an access and mobility management function (AMF), an initial user equipment (UE) message for requesting a registration of the terminal after the RRC setup complete message is received, and control the transceiver to receive, from the AMF, an initial UE context setup request message including NCR authentication information for the terminal based on the initial UE message, and
wherein the NCR authentication information for the terminal indicating that the terminal is authorized as the NCR.

28. The base station of claim 27, wherein the controller is further configured to use the NCR authentication information for the terminal for configuring information for the terminal.
